(19) United States
(12) Patent Application Publication
(10) Pub. No.: US 2008/0212835 A1
(43) Pub. Date: Sep. 4, 2008

(54) Object Tracking by 3-Dimensional Modeling

(76) Inventor: Amon Tavor, Hod Hasharon (IL)

Correspondence Address: Haggai Borkow, 5 Kadima st., Herzlia, 46250, omitted

(21) Appl. No.: 12/038,838

(22) Filed: Feb. 28, 2008

Related U.S. Application Data
(60) Provisional application No. 60/892,255, filed on Mar. 1, 2007.

(51) Int. Cl. G06K 9/00

(52) U.S. Cl. 382/103

(57) ABSTRACT

Disclosed a method for tracking 3-dimensional objects, or some of these objects' features, using range imaging for depth-mapping merely a few points on the surface area of each object, mapping them onto a geometrical 3-dimensional model, finding the object's pose, and deducing the spatial positions of the object's features, including those not captured by the range imaging.

### CROSS-REFERENCE TO RELATED APPLICATIONS

This application claims priority from provisional application No. 60/892255, filed on Mar. 1, 2007.

### BACKGROUND OF THE INVENTION

This invention pertains to the fields of computer vision, machine vision and image processing, and specifically to the sub-fields of object recognition and object tracking.

There are numerous known methods for object tracking, using artificial intelligence (computational intelligence), machine learning (cognitive vision), and especially pattern recognition and pattern matching. All these tracking methods have a visual model to which they compare their inputs. This invention does not use a visual model. It uses a model of the 3-dimensional characteristics of the object tracked.

The purpose of this invention is to enable the tracking of 3-dimensional objects even when almost all of their surface area is not sensed by any sensor, all without depending on prior knowledge of characteristics such as shapes, textures, colors; without requiring a training phase; and without being sensitive to lighting conditions, shadows, and sharp viewing angles. Another purpose of this invention is to enable a faster, more accurate and less processing-intensive object tracking. This is important in a variety of applications, including that of stereoscopic displays.

### BRIEF SUMMARY OF THE INVENTION

According to this invention, range imaging of a 3-dimensional object is used to depth-map some feature points on its surface area, i.e., to track the spatial position along the x, y and z axes of some points.

The feature points tracked are fitted onto a geometrical 3-dimensional model, so the spatial position of each of the 3-dimensional model points can be inferred.

Motion-based correlation is used to improve accuracy and efficiency.

### BRIEF DESCRIPTION OF THE DRAWINGS

FIG. 1 shows range imaging, via a pair of cameras, of a 3-dimensional object (human face) to find feature points.

FIG. 2 shows feature points fitted onto a 3-dimensional geometric head model.

FIG. 3 shows the use of feature points motion to facilitate correlation of feature points from stereo images.

FIG. 4 shows a flow-chart of the tracking process.

### DETAILED DESCRIPTION OF THE INVENTION

According to this invention, range imaging of a 3-dimensional object is used to depth-map some feature points on its surface area, i.e., to track their spatial position along the x, y and z axes of some points.

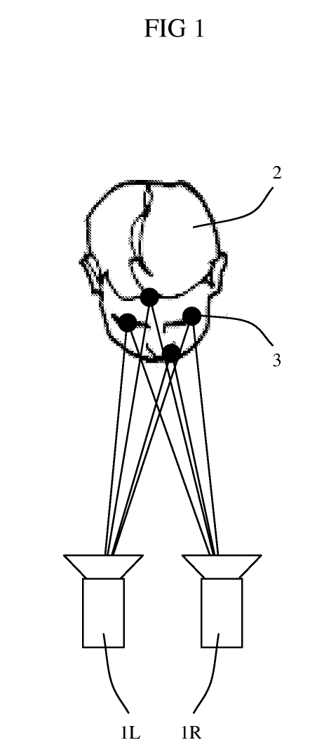

The range imaging can be done in any one of several techniques. For example, as shown in FIG. 1, by stereo triangulation: using two cameras (1L and 1R) to capture a physical object (2), obtaining stereo correspondence between some surface points (3) on the surface area of the 3-dimensional object captured in the two images. Alternatively, the range imaging can be done using other range imaging methods.

The tracked 3-dimensional object can be rigid (e.g., metal statue), non-rigid (e.g., rubber ball), stationary, moving, or any combination of all of the above (e.g., palm of a hand with fingers and nails).

The feature points tracked (in [0007] above) are detected in each camera image. A feature point is defined at the 2-dimensional coordinate of the center of a small area of pixels in the image, with significant differences in color or intensity between the pixels in the area. The feature points obtained from two camera are paired by matching the pixel variations of a feature point from one camera with a feature point from the second camera. Only feature points with the same vertical coordinate in both cameras can be matched. The difference in the two horizontal coordinates of the feature point allows to infer (by inverse ratio) its position along the z axis.

Thanks to their definition (e.g., same vertical coordinate, and large pixel variations) and the use of the range imaging, the feature points defined in [0010] above are easy to find and match, simplifying the algorithms needed, and reducing the processing time and power requirements.

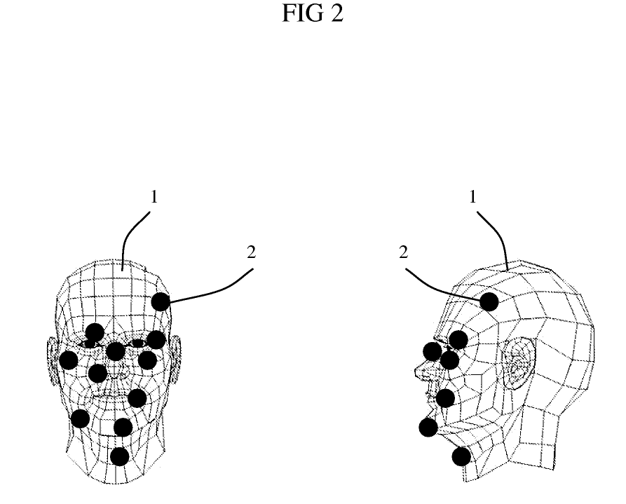

The feature points tracked (in [0007] above) are fitted onto a geometrical 3-dimensional model: The pose of the physical object is approximated by iteratively varying the pose of the 3-dimensional geometrical model with 6 degrees of freedom, and trying to fit the points with the object in each pose. Fitting is calculated by summation of the distances of the points from the surface of the object model, where the smallest sum denotes the best fit. The number of iterations can be reduced by known mathematical methods of minimum search optimization. FIG. 2 shows how point 2 is fitted onto the 3-dimensional object (1).

The spatial position of each of the 3-dimensional model's features and components can be inferred using their relative position to the absolutely known (inferred in [0012] above) position of the 3-dimensional object. Likewise, the spatial position of other points, whose relative position in relation to the 3-dimensional object is known, can be inferred, whether they are inside or outside the 3-dimensional object.

The geometrical 3-dimensional model can be generic, or learned, using known methods.

When several geometrical 3-dimensional models are applicable, the feature points tracked are fitted onto each of these models, as explained in [0012] above for a single geometrical model, and the best match is used to supposedly provide the position of the 3-dimensional object with 6 degrees of freedom.

Alternatively, 3-dimensional models may have variable attributes, such as scale or spatial relationship between model parts for non-rigid objects. In these cases the additional variables are also iterated to find the captured object's attributes in addition to its pose.

Since this invention provides the position of the 3-dimensional object, the spatial position of points on the surface area (or inside, or outside of the 3-dimensional object) that are not recognized, or even captured by the range imaging, are inferred.

The difference in the two horizontal coordinates of a feature point allows to infer, by inverse ratio, its position along the z axis. Following the fitting of the feature points onto the geometrical 3-dimensional model, the coordinates of the physical object are found with six degrees of freedom, including its position along the z axis. This enables an easy differentiation between the (near) object and its (distant) background. If motion prediction (as explained in [0026] below) is used, any feature point whose spatial coordinates are significantly different from the spatial coordinates of the predicted object can be filtered. This method can be aids in solving the long-standing problem of separating figure and ground (object and background) in common tracking methods.

The 3-dimensional objects tracked can be biological features, specifically faces, limbs and hands, human or not. Since the location of facial features can be inferred (as their relative location in the human head is known), this invention allows localization of features that are not always captured by the range imaging, such as ears and eyes behind dark glasses.

When tracking human faces (for example in the context of active stereoscopic displays) this invention requires very little training, if at all, and very little processing power.

Although this invention makes 2-dimensional feature recognition techniques unnecessary, this invention can be used in combination with other methods, yielding better results with less processing power. For example, in the context of tracking human faces, after inferring the location of the eyes from the position of the head, the eyes can be recognized visually, while limiting the visual search to a small area around their estimated location, thus reducing computation power. Moreover, the visual search is further optimized because since both the pose of the face and the angle between the image sensors and the face are known, the system knows how the visual representation of the eyes should look like, simplifying the search.

Hence, using our invention to locate the head to infer the position of the eyes, and then visually search in a small area optimally (knowing what images should be captured), enables the unprecedented pinpointing of the gaze's direction.

When range imaging is continuous the stereo correspondence detection of the 3-dimensional object is facilitated by motion-based correlation of feature points, which allow the filtering of noise, and reduces processing requirements as it more easily eliminates false matches. This is always helpful, and especially relevant when the range imaging of the 3-dimensional object is done with a wide angle between two points of view, and when different components of the 3-dimensional object move in different directions and speeds (e.g., the fingers in the palm of a hand).

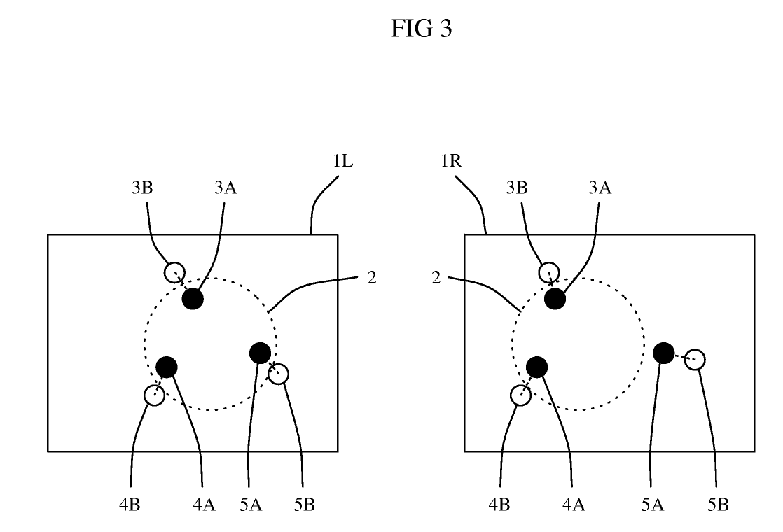

FIG. 3 shows how this is done (when the range imaging is obtained via visual stereo capture): Left (1L) and right (1R) successive frames of the (hypothesized) physical 3-dimensional object (2) are obtained. Each of the feature points (3, 4 and 5) are independently compared across frames (3B to 3A, 4B to 4A and 5B to 5A) in the disparate views, in order to determine if these points in the disparate views denote the same point in physical space.

To illustrate, here's a short analysis of the three feature points shown. Feature point 4 has the same motion vectors in 1L and 1R (the angle and length of the line connecting 4B and 4A in 1L are equal to the line connecting 4B and 4A in 1R), so it is very probable that 4 in 1L and 4 in 1R are the same point. Feature point 3 has motion vectors that require a somewhat more complex analysis: the vertical motion vector is identical in 1L and 1R (the distance between 3B and 3A in both views is identical along the y axis), but the horizontal motion vector is different in 1L and 1R (the distance between 3B and 3A along the x axis is shorter in 1R than in 1L). The identical vertical vector implies that it is very probable that feature point 3 is indeed the same point in 1L and in 1R, and the different horizontal vector implies that feature point 3 moved along the z axis. Feature point 5 vertical and horizontal motion vectors are different for 1L and 1R, implying that it is very probable that feature point 5 is not the same point in 1L and in 1R, and is thus mere noise that should be filtered.

This invention enables motion prediction which reduces noise, time and processing requirements: based on the tracked movement of the physical 3-dimensional object in the preceding frames, the system extrapolates where the object should be in the next frame, vastly limiting the area where the search for feature points is made, and decreasing the propensity of false matches. This applies to the movement of the whole object, and to all of its parts, along and around any and all axes.

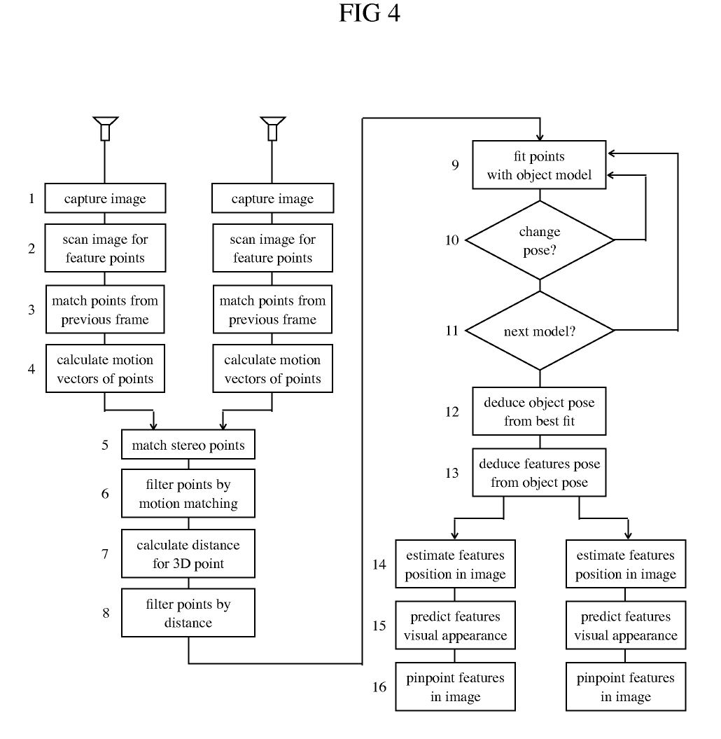

The various phases of this invention can be applied in various consecutive and overlapping stages. One recommended work-flow (that assumes that range imaging is done via visual stereo capture) is shown in FIG. 4. Step 1: Each of the two image sensors captures an image that supposedly includes the 3-dimensional object from a different point of view. Step 2: The system scans the images in order to find feature points as explained in [0010] above. If motion prediction is used as explained in [0026] above, scanning can be limited to the area predicted to contain the object in each image. Step 3: The feature points are compared across frames as explained in [0023] above. Step 4: The motion vectors of the feature points are calculated. Step 5: The feature points are matched. Step 6: Feature points are filtered using motion based correlation as explained in [0023] above. [Again, vertical motion should always match in both images. Horizontal motion can differ if the distance of the object changes. If motion prediction is used, the difference in horizontal motion can also be predicted.] Step 7: Use triangulation in order to calculate the distance of the feature points from the image sensors. Step 8: Filter feature points by their distance as explained in [0018] above. Again, if the background is significantly further than the tracked object, background points are identified by distance and eliminated. If motion prediction as explained in [0026] above is used, any point significantly different from the predicted object distance can be eliminated. Step 9: Fit the feature points with the 3-dimensional geometrical model as explained in [0012] above. Step 10: If needed, the hypothesized pose of the physical 3-dimensional object is changed to receive a better fit with the feature points tracked, as explained in [0012] above. If motion prediction is used, pose iterations are limited to the range of poses predicted. Step 11: If there are several geometrical models as mentioned in [0014] above, the best fit analysis is done as explained in [0015] above. Once the best fitting geometrical object model has been identified, fitting is limited to this best model while tracking the same object. Step 12: Deduce the spatial coordinates of the physical 3-dimensional object. Step 13: Deduce the object's features that are not captured by the image sensors (e.g., eyes behind dark glasses, or ears), as explained in [0017] above. Step 14: Using the known spatial relations (including angle and distance) between the image sensors and the physical object, the optical characteristics of the image sensors (including angle range), and the known 3-dimensional characteristics (including dimensions) of the physical object, to estimate the position of the 2-dimensional projection of the physical object and its features in the image obtained in each of the image sensors. As explained in [0022] this is very helpful in 2-dimensional feature recognition techniques. Step 15: Using the same information as in step 14 above, estimate the visual characteristics (appearance) of the 2-dimensional projection of the physical object and its features in the image obtained in each of the image sensors. As explained in [0022] this is very helpful in 2-dimensional feature recognition techniques. Step 16: Pinpoint features in image. Visual tracking (for example using shape fitting or pattern matching) of the features is limited to their position and appearance inferred from the object pose in each image. Their exact position can be used to increase the accuracy and reliability of the object tracking. It can also be used to measure the position of movable features relative to the object. A good example would be measuring the pupils position relative to the head for gaze tracking.

### PREFERRED EMBODIMENT

In a preferred embodiment, the invention is used to track the eyes of a computer user seating in front of an autostereoscopic display. The position of the eyes needs to be tracked continuously, so the computer can adjust the optics of the display or the graphics displayed on the screen, in order to maintain three-dimensional vision while the user moves his head.

Two web cameras are mounted on the screen, both pointing forward toward the user's face, and spaced apart a few centimeters horizontally. The cameras are connected electronically to the computer by serial data connections.

The software on the computer contains geometric data for several three-dimensional models of human heads, accommodating various human head structures, typical to various races, ages and gender.

The software repeatedly captures images from both cameras synchronously, and scans the images to find feature points as explained above. Irrelevant points are eliminated by motion correlation, distance and motion prediction as explained above.

The software tries to fit the three-dimensional points to a geometric head model, while varying the pose of the model to find the best fit, as explained above. At first the points are fitted to each head model in sequence, and later only to the head model which yields the best fit.

From the head pose the software deduces the eye positions, which are assumed to have known positions on each head model. The computer adjusts the stereoscopic display according to the three-dimensional coordinates of each eye.

1. Tracking physical 3-dimensional objects, using range imaging of feature points of said tracked object, and fitting these feature points to a geometrical 3-dimensional model to deduce the spatial position of said tracked object.

2. The method of claim 1, where two image sensors are used for the range imaging of feature points by triangulation.

3. The method of claim 1, where motion-based correlation is used to filter noise by ignoring falsely matched pairs of feature points.

4. The method of claim 1, where differences in the distances of feature points is used to filter noise by discriminating between points that are part of tracked object and points that are in the background.

5. The method of claim 1, where motion prediction is used to limit the range of object poses that need to be tested when feature points are iteratively fitted to a geometrical object model.

6. The method of claim 1, where motion prediction is used to limit the area where feature points are searched to the area containing tracked object within each image.

7. The method of claim 1, where motion prediction is used to filter noise by identifying feature points that are not part of tracked object based on their distance.

8. The method of claim 1, where motion prediction is used with motion correlation to filter noise by identifying feature points that are not part of tracked object based on their motion.

9. The method of claim 1, where feature points are iteratively fitted to several different geometrical 3-dimensional object models to find the best fit.

10. The method of claim 1, where the structure of the geometrical 3-dimensional object model is manipulated by numeric parameters, and said parameters are varied iteratively to find the best fit for detected feature points.

11. The method of claim 1, where said geometrical 3-dimensional object model is learned by gradually adapting the structure of geometric model to fit the 3-dimensional feature points detected.

12. The method of claim 1, where the positions of features of said tracked object are inferred from the object pose.

13. The method of claim 1, where the inferred positions of features of said tracked object are used to predict the area of said features in each captured image.

14. The method of claim 1, where the inferred positions of features of said tracked object are used to predict the visual appearance of said features in each captured image.

15. The method of claim 1, used together with known visual tracking methods to determine the positions of features of said tracked object in each captured image.

16. The method of claim 1, where the tracked object is a human head, the spatial position of the eyes is inferred from the position of the head, and where visual tracking is used to determine the position of the pupils and deduce the direction of gaze.

17. The method of claim 1, used together with an autostereoscopic display device to track the head of a computer user, infer the spatial position of the eyes and adapt the stereoscopic display to the position of the eyes to maintain 3-dimensional vision.

18. The method of claim 1, used together with an audio playing device to track the user head, infer the spatial position of the ears and adapt the audio playing to the position of the ears to maintain 3-dimensional sound.

19. The method of claim 1, where a tracked object is used as an input device, and the computer responds to changes in the deduced pose of said tracked object.
